(19) United States
(12) Patent Application Publication
(10) Pub. No.: US 2011/0197789 A1
(43) Pub. Date: Aug. 18, 2011

(54) STRONTIUM BASED SOLUTIONS AND PROCESSES FOR SURFACE HARDENING OF CONCRETE AND OTHER CEMENTEOUS MATERIALS AND STRUCTURES MADE THEREBY

(75) Inventors: STEPHEN E. NOVAK, Harrisburg, NC (US); ASHLEY D. MEADOWS, Harrisburg, NC (US); MAVIS W. JONES, Harrisburg, NC (US)

(73) Assignee: Chemical Specialties, Harrisburg, NC (US)

(21) Appl. No.: 13/014,884

(22) Filed: Jan. 27, 2011

Related U.S. Application Data
(60) Provisional application No. 61/298,688, filed on Jan. 27, 2010.

(51) Int. Cl. B05D 3/10; C04B 28/00; B05D 5/00; B05D 1/02; B05D 1/28

(52) U.S. Cl. 106/638; 427/344

(57) ABSTRACT

The invention relates to a composition and method for effectively increasing the hardness of a concrete surface and other cementeous materials. More specifically, increasing hardness of concrete by applying a strontium based solution to its surface, and the structure made by the method. The invention also relates to application of surfactants and/or other additives in order to improve the penetration of the hardening agent into the concrete surface and other cementeous materials, improve the water and/or oil repellant properties of the concrete, and/or improve its stain resistance.

### CROSS REFERENCE TO PRIOR APPLICATIONS

This application claims priority and the benefit thereof from a U.S. Provisional Application No. 61/298,688, filed on Jan. 27, 2010 and entitled STRONTIUM BASED SOLUTIONS AND PROCESSES FOR SURFACE HARDENING OF CONCRETE AND OTHER CEMENTEOUS MATERIALS AND STRUCTURES MADE THEREBY, the entire contents of which are herein incorporated by reference in their entirety.

### FIELD OF THE INVENTION

The invention relates to a composition and method for effectively increasing the hardness of a concrete surface and other cementeous materials. More specifically, increasing hardness of concrete by applying a strontium based solution to its surface, and the structure made by the method. The invention also relates to application of surfactants and/or other additives in order to improve the penetration of the hardening agent into the concrete surface and other cementeous materials, improve the water and/or oil repellant properties of the concrete, and/or improve its stain resistance.

### BACKGROUND OF THE INVENTION

Cement, such as Portland cement, is commonly used in the production of concrete, a material widely used in the construction of structures such as commercial buildings, homes and roads. Concrete surfaces, particularly in high traffic areas, can show wear and tear over time. It is common industry practice to apply alkali silicate solutions of sodium (Na), potassium (K), and lithium (Li) to harden and seal concrete surfaces, such as floors and other high foot traffic areas. The most widely used surface hardener in industry is lithium silicate. Lithium silicate is used to make concrete surfaces last longer, by being more impact and stain resistant. Some alternatives, like organic polymer-based sealers such as acrylics, create an impervious coating on the surface of the concrete, but do not harden the concrete.

U.S. Reissued Pat. No. RE38,364 E to Mark Wetherell, et al., discloses a method for hardening and polishing concrete floors, walls and the like by applying to the concrete surface, a hardening densifying silicate compound. It specifically discloses the use of silicates as a polishing compound for concrete.

However, the use of alkali silicates to harden and seal concrete surfaces has many drawbacks and negative side effects. First, the best performing silicate, lithium silicate is expensive. Second, alkali silicates are caustic and present safety concerns to people who are applying the chemicals. Dry silica is carcinogenic and poses an inhalation hazard. Third, most alkali silicates leave a crystal or dust-like residue after drying. This caustic silica dust must be removed by broom, scrubber or acid wash adding to the potential hazards for the worker. Fourth, concrete and cement mixes high in alkali content experience alkali silica reactivity (“ASR”). When concrete gets wet, the moisture combines with the free alkali in the concrete to dissolve the silica and create a gel like substance that expands the concrete, thereby damaging it. The alkali silicates contribute free alkali to the concrete which increases the risk of ASR. Finally, when concrete or cement containing free alkali is wetted, the alkali may bleed out of the surface and create esthetically unsightly white stains on the concrete surface. There are additional disadvantages.

A need exists to harden and seal concrete surfaces without many of the drawbacks and disadvantages of using silicate as the hardening agent.

### SUMMARY OF THE INVENTION

This invention is directed to using strontium based solutions as a hardening agent to the concrete that is less costly than lithium silicate, easier to apply, less caustic and hazardous than alkali silicates, produces no hazardous byproducts, leaves no residue on the concrete, does not increase the probability of ASR, reduces the potential for efflorescence, results in concrete with greater surface hardness, along with other advantages.

This invention may also include the application of ionic and/or non-ionic surfactants to the concrete to improve the penetration of the hardening agent into the concrete, and/or silanes, siliconates, siloxanes or other silicon-based additives to the concrete to improve the water or oil repellency properties of the concrete, or to improve its stain resistance.

Additional features, advantages, and embodiments of the invention may be set forth or apparent from consideration of the following attached detailed description and drawings. Moreover, it is to be understood that both the foregoing summary of the invention and the following attached detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a method for increasing the hardness (hardening) concrete surfaces and other cementeous materials, and/or improving penetration of the hardening agent, and/or improving water and/or oil repellant properties and/or improving stain resistant properties of concrete surfaces and other cementous materials, according to an embodiment of the invention.

FIG. 2 shows a graphical representation of the analysis comparing the Taber Index of lithium silicate and strontium nitrate treated cement specimens provided as example 1 below.

FIG. 3 shows a graphical representation of the analysis of the Taber Index of untreated cement specimens provided as example 1 below.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The invention is directed to a process for hardening a concrete surface and other cementeous materials using a hardening agent such as strontium nitrate, other strontium based solutions or solids such as strontium chloride, strontium acetate, strontium bromide, strontium carbonate, strontium hydroxide or strontium oxide. The hardening agent may also include blends of strontium based chemicals with non-strontium based additives, including, but not limited to, solutions of silicates, chlorides, nitrates, acetates and bromides. This process may be repeated several times as necessary.

The invention also provides a process for improving the penetration of the hardening agent into the concrete by mixing ionic and/or non-ionic surfactants with the hardening agent that is applied to the concrete. Alternatively, the ionic and/or non-ionic surfactants can be applied to the concrete before or after the application of the hardening agent to the concrete. This process may be repeated several times as necessary.

The invention also provides a process for improving the water and/or oil repellant properties and/or stain resistant properties of the concrete by mixing silanes, siliconates, siloxanes, and/or other silicon-based additives with the hardening agent that is applied to the concrete. Alternatively, the silanes, siliconates, siloxanes, and/or other silicon-based additives can be applied to the concrete before or after the application of the hardening agent to the concrete. This process may be repeated several times as necessary.

The invention further provides a process for introducing the hardening agent, and/or surfactants, and/or silicon-based additives to a concrete surface and other cementeous materials. Finally, the invention is directed to a cement structure having a hardened surface, and/or improved water repellant surface, and/or improved oil repellant surface, and/or improved stain resistant surface according to the process.

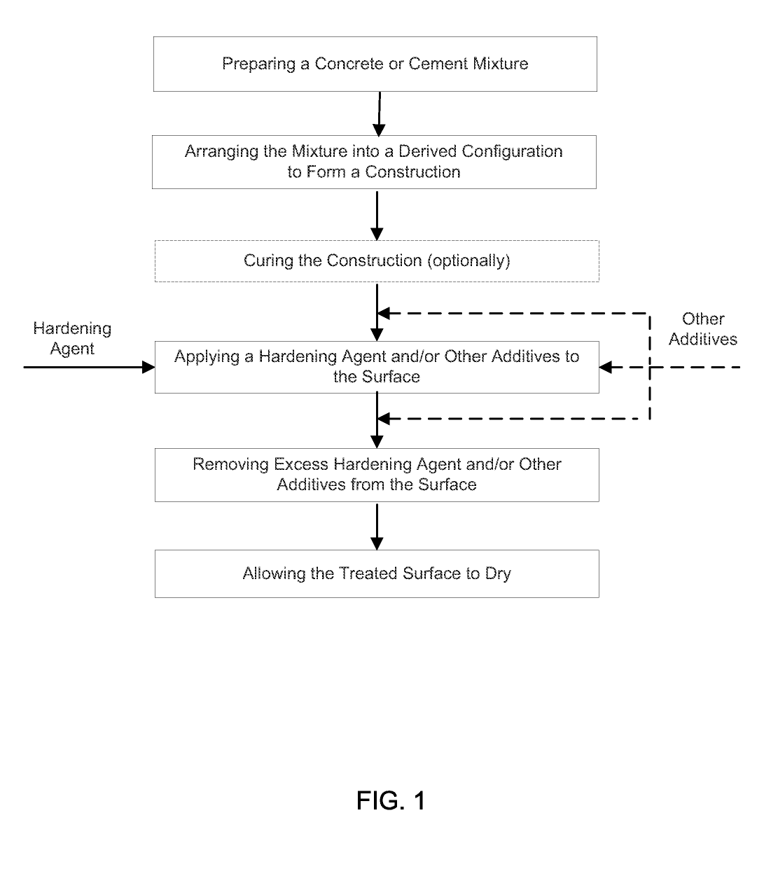

FIG. 1 shows a method for increasing the hardness (hardening) concrete surfaces and other cementeous materials, and/or improving penetration of the hardening agent, and/or improving water and/or oil repellant properties and/or improving stain resistant properties of concrete surfaces and other cementous materials, according to an embodiment of the invention.

Referring to FIG. 1, the method may begin by preparation of a concrete or cement mixture. Such cement mixture may be Portland cement, a commonly used type of cement in the production of construction material, or Portland cement blends. The cement may be combined with other materials to form concrete as is well known in the art. Next, the mixture may be arranged into a desired configuration, such as by use of forms and/or molds, to form a construction. The construction of the concrete may be worked using standard industry tools, and then cured using standard industry curing practices for an appropriate number of hours and/or days.

A hardening agent having at least one of strontium nitrate, other strontium based solutions or solids and blends thereof, including strontium chloride, strontium acetate, strontium bromide, strontium carbonate, strontium hydroxide, or strontium oxide is then applied to the surface of the concrete or cement mixture. The hardening agent may also include blends of strontium based chemicals with non-strontium based additives, including, but not limited to, solutions of silicates, chlorides, nitrates, acetates, bromides, ionic surfactants, non-ionic surfactants, silanes, siliconates, siloxanes, and other silicon-based additives. The process may be repeated several times as necessary. A hardening solution may contain thirty percent (30%) strontium nitrate. Application of the hardening solution may occur either by adding the hardening agent to the concrete mixture before arranging the concrete mixture into a desired configuration, or alternatively, may be applied to the concrete after the construction is cured. Curing may take from one to thirty days. The hardening agent may take at least one of a liquid or powder form, and may be applied to a construction surface by mixing it into the concrete mixture, or spraying, rolling, brushing, or mopping it onto a construction surface.

The equipment used to apply a strontium based hardening agent, such as a sprayer, roller, brush, or mop, may clean readily with water and may be free of hazardous waste and by products. Unlike silicate-based solutions, there is less disposal issues and health hazard concerns for the person applying a strontium based agent.

The strontium based solutions may be enhanced with wetting agents, such as ionic and/or non-ionic surfactants, to improve absorption of the hardening agent into the concrete construction. The surfactants may be mixed with the hardening agent and then applied to the concrete, or the surfactants may be applied to the concrete before or after the application of the hardening agent.

The strontium based solutions may also be enhanced with silanes, siliconates, siloxanes, and/or other silicon-based additives, to improve the water and/or oil repellant properties and/or stain resistance of the concrete. These other additives may be mixed with the hardening agent and then applied to the concrete, or these additives may be applied to the concrete before or after the application of the hardening agent. The hardening agent and/or other additives may also be reapplied as necessary.

Once application of a hardening agent and/or other additives is complete, the treated surface may then be allowed to dry. The concrete surface may be allowed to cure over a period of 1 to 30 days. This results in a construction, which may include floors, interior walls, exterior walls, beams and columns and other structural members, pavers, conduits, and tanks, with a greater surface hardness and/or tensile strength stronger than untreated cement and as strong as or stronger than cement treated with lithium silicate.

Benefits from the application of a strontium based hardening agent with other additives may include a harder construction surface than use of alkali silicate products and at lower cost, less caustic and safer than alkali silicate products, improved water and/or oil repellant properties, improved stain resistance, no generation of hazardous byproducts, ease of handling and applying the agent, may not increase the probability of ASR, and may reduce the potential for efflorescence by filling cement surface pores and capillaries, and prevent water absorption.

By way of example, but not of limitation, an example of the invention will now be given.

### Example 1

Cement tiles were prepared using Quikrete® sand mix and tap water at 6 parts concrete to 1 part water by weight. Quikrete® Sand/Topping Mix Number 1103 was chosen because it does not contain an admixture, which could affect the strengthening of the concrete or aggregate and distort hardness testing results.

The sand mix and water were added to a mixing bowl, mixed with a Hobart N50 Tabletop mixer for two minutes on the lowest setting, allowed to rest for two minutes, and then mixed again for another minute. After the mixer was removed, the mixing bowl contents were vibrated for 5 minutes using a sander in order to remove any entrapped air.

The cement was then placed into a wooden mold, with an interior dimension of 12 inches×12 inches×⅜ inches, and the wooden mold was placed on Plexiglas®. The cement was then screeded using a trowel until the surface was flat and smooth from one side to the other. After approximately thirty minutes the cement was scored into nine 4 inch×4 inch tiles, and then cured for six days in a room temperature environment.

After the six days, some of the cement was treated with a solution of 30% strontium nitrate [Sr(NO₃)₂] by weight using a paint brush. The paint brush was dipped in the strontium nitrate solution, the excess solution wiped off, and the brush then brushed across the surface of the cement. Concurrently, some of the cement was treated with lithium silicate by using a paint brush. Tiles treated with lithium silicate (LiSil), and tiles treated with strontium nitrate were then analyzed in tandem.

The treated tiles were analyzed for its Taber® Wear Index one day after treatment, and thereafter in three to four day intervals. Analysis was performed using the Taber® Abraser Model 5135 with an H-22 Calibrade® Abrading Wheel, on a 1,000 gram load abraded for 200 cycles at 60 revolutions per minute. The Taber® Wear Index decreases as the specimen becomes harder, and the lower the Taber® Index, the better the abrasion resistance. The Taber® Index was calculated based on the amount of weight loss during the analysis:

Taber® Wear Index=[(A−B)*1000]/Number of cycles
where A=weight of test specimen before abrasion
   B=weight of test specimen after abrasion

The weight of the test specimens were measured with a Sartorius® ELT602 scale. Table 1 provides the results of the analysis, on cement prepared Jul. 22, 2009 and treated Jul. 28, 2009:

TABLE 1

| | Elapsed Time | Taber |
|---|---|---|
| Treatment | (Days) | Index |
| LiSil | 1 | 41.15 |
| SrNO3 | 1 | 28.65 |
| LiSil | 6 | 24.60 |
| SrNO3 | 6 | 10.55 |
| LiSil | 9 | 19.15 |
| SrNO3 | 9 | 13.75 |
| LiSil | 13 | 10.20 |
| SrNO3 | 13 | 7.20 |
| LiSil | 16 | 17.15 |
| SrNO3 | 16 | 9.40 |
| LiSil | 21 | 7.60 |
| SrNO3 | 21 | 6.00 |
| LiSil | 24 | 10.95 |
| SrNO3 | 24 | 7.75 |
| LiSil | 28 | 8.35 |
| SrNO3 | 28 | 5.55 |
| LiSil | 34 | 8.75 |
| SrNO3 | 34 | 5.05 |
| LiSil | 37 | 7.90 |
| SrNO3 | 37 | 6.20 |
| LiSil | 42 | 8.85 |
| SrNO4 | 42 | 6.75 |
| LiSil | 45 | 11.05 |
| SrNO5 | 45 | 5.20 |
| LiSil | 48 | 10.05 |
| SrNO5 | 48 | 4.15 |

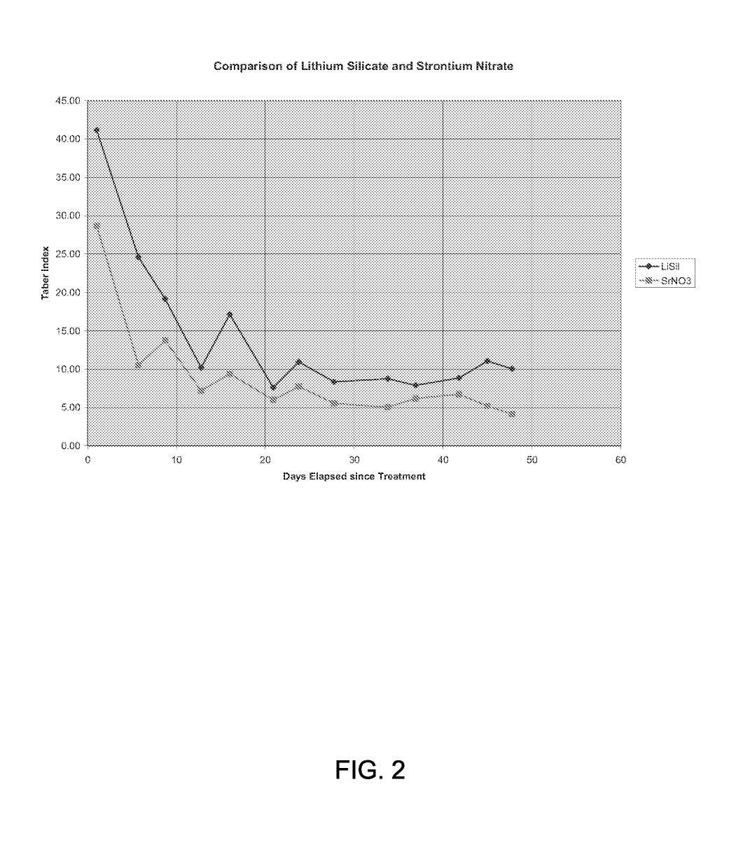

FIG. 2 shows a graphical representation of Table 1, the analysis comparing the Taber Index of lithium silicate and strontium nitrate treated cement specimens provided in this example.

In addition, untreated cement tiles were also observed over a comparable timeframe and the Taber® Index calculated based on the amount of weight loss during the analysis period. Table 2 provides the results of the analysis on untreated cement:

TABLE 2

| | Elapsed Time | Taber |
|---|---|---|
| Treatment | (Days) | Index |
| Untreated | 7 | 55.85 |
| Untreated | 11 | 25.05 |
| Untreated | 13 | 48.50 |
| Untreated | 17 | 38.15 |
| Untreated | 20 | 36.25 |
| Untreated | 23 | 65.95 |
| Untreated | 27 | 42.05 |
| Untreated | 30 | 36.45 |
| Untreated | 42 | 33.15 |
| Untreated | 44 | 31.95 |

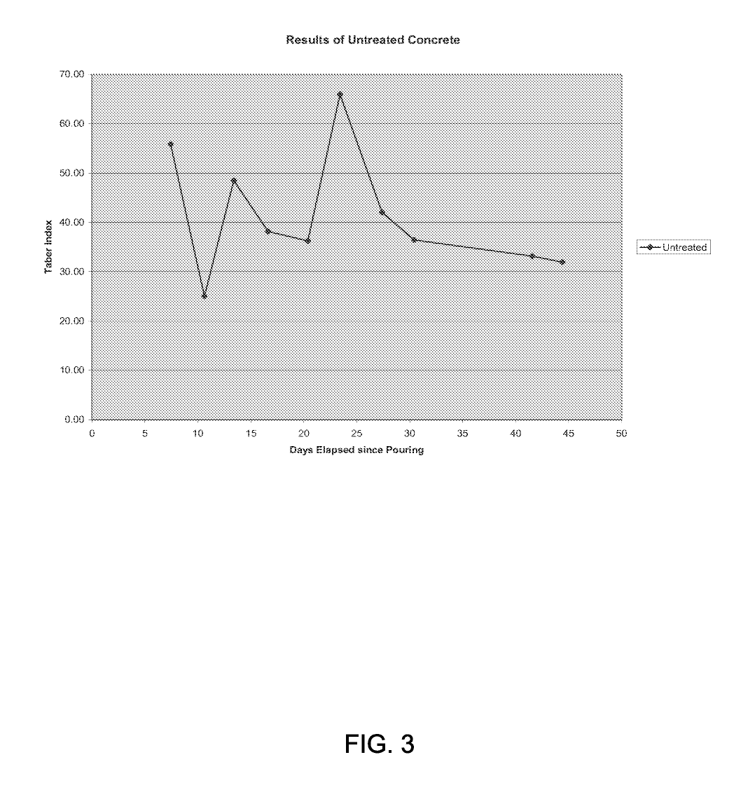

FIG. 3 shows a graphical representation of Table 2, the analysis of the Taber Index of untreated cement specimens provided in this example.

Results show that after treatment, both the strontium nitrate and the lithium silicate demonstrated marked increases in hardness of the cement, with the strontium nitrate showing statistically greater hardness than the lithium silicate. For example, on day 13 the Taber Index for concrete treated with strontium nitrate, lithium silicate, and untreated concrete was 7.20, 10.20, and 48.50, respectively. On day 42, the Taber Index for concrete treated with strontium nitrate, lithium silicate, and untreated concrete all showed increases in hardness of the cement, to 6.75, 8.85, and 33.15, respectively. The lower Taber Index for strontium nitrate compared with the other two alternatives indicated that strontium nitrate produced the hardest and most resistant cement surface.

The strontium nitrate was easily applied and readily absorbed into the concrete. It dried to a smooth shiny, glass-like finish producing no visible residue. Equipment with strontium nitrate cleaned readily in water. Conversely, the lithium silicate specimens formed crystals and dust on the concrete surface and the concrete did not feel as smooth to the touch as the strontium nitrate-treated concrete.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A method for increasing the hardness of a concrete surface and other cementeous materials, comprising:
preparing a concrete or cement mixture;
arranging the mixture into a desired configuration to form a construction;
applying a hardening agent to the surface, wherein the hardening agent comprises at least one of: strontium nitrate, other strontium based solutions and blends thereof such as strontium chloride, strontium acetate, strontium bromide solutions and strontium based solids such as strontium carbonate, strontium hydroxide and strontium oxide, and blends of strontium based solutions or solids with non-strontium based hardeners including silicate, nitrate, acetate, chloride and bromide based solutions;
allowing the treated concrete surface to dry.

2. The method of claim 1, wherein the hardening agent is enhanced with at least one of:
ionic surfactants;
non-ionic surfactants;
silanes;
siliconates;
siloxanes;
other silicon-based additives; and
combinations thereof.

3. The method of claim 1, wherein the construction comprises at least one of:
floors;
interior walls;
exterior walls;
columns;
beams;
structural members;
pavers;
conduits; and
tanks.

4. The method of claim 1, further comprising the step of curing the construction.

5. The method of claim 4, wherein the construction is cured from one to thirty days.

6. The method of claim 1, further comprising the step of applying at least one of the following additives:
ionic surfactants;
non-ionic surfactants;
silanes;
siliconates;
siloxanes;
other silicon-based additives; and
combinations thereof one of before and after the application of the hardening agent, and/or mixed with the hardening agent applied to the concrete.

7. A process for introducing a hardening agent to a concrete surface and other cementeous materials, comprising at least one of:
adding the hardening agent to the concrete mixture before pouring the cement mixture into a desired configuration to form a construction; and
applying the hardening agent to the surface one of before and after curing,
wherein the hardening agent comprises strontium.

8. The process of claim 7, wherein a hardening agent comprises at least one of the following forms:
liquid; and
powder.

9. The process of claim 7, wherein a hardening agent is applied to a surface of the construction by at least one of:
mixing;
spraying;
rolling;
brushing; and
mopping.

10. The process of claim 7, wherein a hardening agent is reapplied as necessary.

11. A process for introducing an additive to a concrete surface and other cementeous materials, comprising at least one of:
adding the additive and hardening agent to the concrete mixture before pouring the cement mixture into a desired configuration to form a construction;
applying the additive to the concrete mixture before applying a hardening agent to the concrete mixture; and
applying the additive to the concrete mixture after applying a hardening agent to the concrete mixture,
wherein the hardening agent comprises strontium.

12. The process of claim 11, wherein an additive comprises at least one of the following forms:
liquid; and
powder.

13. The process of claim 11, wherein an additive is applied to a surface of the construction by at least one of:
mixing;
spraying;
rolling;
brushing; and
mopping.

14. The process of claim 11, wherein an additive is reapplied as necessary.

15. A construction formed by the method of claim 1.

16. A construction formed by the method of claim 7.

17. A construction formed by the method of claim 11.
